(19) United States
(12) Patent Application Publication
(10) Pub. No.: US 2013/0097137 A1
(43) Pub. Date: Apr. 18, 2013

(54) Integrating Social Networking and Query Submission

(71) Applicants: Barry A. Kritt, Research Triangle Park, NC (US); Sarbajit K. Rakshit, Kolkata (IN); Shawn K. Sremaniak, Research Triangle Park, NC (US)

(72) Inventors: Barry A. Kritt, Research Triangle Park, NC (US); Sarbajit K. Rakshit, Kolkata (IN); Shawn K. Sremaniak, Research Triangle Park, NC (US)

(73) Assignee: INTERNATIONAL BUSINESS MACHINES CORPORATION, Armonk, NY (US)

(21) Appl. No.: 13/273,769

(22) Filed: Oct. 14, 2011

(51) Int. Cl. G06F 17/30

(52) U.S. Cl. 707/706; 707/E17.108

(57) ABSTRACT

Embodiments of the invention relate to augmentation of query suggestions in response to a query submission. One or more friends or friendship circles are identified in a social networking aspect of a search engine. Responsive to receipt of the query submission and identification of at least one friend from the social networking aspect, two sets of query suggestions are provided. The sets of query suggestions include both query suggestions from a search engine and query suggestions from a social networking channel.

### BACKGROUND

1. Technical Field

The present invention relates to a method and system for integration of a social networking channel with query submission. More specifically, the invention relates to a system and method that combines the tools of a search engine and the social networking channel to return query suggestions from a query submission.

2. Description of the Prior Art

A web browser is an application software or program designed to enable users to access, retrieve and view documents and other resources on the Internet. Accessible from the web browser is a class of programs known as search engines. The search engine is a program that searches documents for specified keywords and returns a list of the documents where the keywords were found. Typically, a search engine works by sending out a spider to fetch as many documents as possible. Another program, called an indexer, then reads these documents and creates an index based on the words contained in each document. Each search engine uses an algorithm to create its indices such that, ideally, only meaningful results are returned for each query submitted.

As search engines have evolved, so has the process of providing query results. More specifically, search engines are known for providing query suggestions as the query is in the process of being submitted. Whether through the query suggestions submitted or the query suggestions provided by the search engine, the user is burdened with selecting an appropriate query result.

### SUMMARY OF THE INVENTION

This invention comprises a method, system, and apparatus for leveraging social networking with a query submission.

In one aspect of the invention, a method is provided for submitting a query to a search engine. More specifically, the query is integrated with a social networking channel, which includes selecting at least one friendship circle present in the social networking channel. Response to receipt of the query, the social networking channel identifies one or more query suggestions and query results from the networking channel. One or more query suggestions are returned with the query suggestions including both a query suggestion from the social networking channel as well as a suggestion from the search engine in receipt of the query.

In another aspect, a computer program product is provided. The computer program product includes a computer-readable storage medium having computer readable program code embodied thereon, which when executed causes a computer to implement a method for integrating a search engine query with a social networking channel. More specifically, the computer program product supports receipt of a query term submitted to a search engine. In response to receipt of the query, computer readable program code is provided to integrate the submitted query with the social networking channel, and more specifically to select a friendship circle from the social networking channel. Computer readable program code is also provided to identify at least a first query suggestion from the social networking channel and a second query suggestion from the search engine.

In yet another aspect, a system is provided with a processor in communication with memory. A functional unit is provided in communication with the memory and includes tools to support return of query results from a query submission to a search engine. More specifically, the functional unit includes a query manager to submit a query term to the search engine. An integration manager, which is in communication with the query manager, integrates the submitted query with a social networking channel through selection of a friendship circle present within the social networking channel. At least two query suggestions are provided, including a first query suggestion provided by the search engine and a second query suggestion provided by the social networking channel. In addition, a result manager is provided in communication with the social networking channel to return the query suggestions, including both the first and second query suggestions.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts a process for employing both a search engine and a social networking channel to provide a bifurcated search engine optimization.

FIG. 2 depicts a flow chart illustrating a process for utilization of the social networking channel.

FIG. 3 depicts a flow chart demonstrating the hierarchical representation of returned query suggestions.

FIG. 4 depicts a flow chart illustrating a process for forming the hierarchical arrangement of query suggestions.

FIG. 5 depicts a block diagram illustrating tools embedded in a computer system to support an efficient and effective return of query suggestions from both a search engine and a social networking channel.

FIG. 6 depicts a block diagram of an example of a bifurcated query suggestion presentation provided on the visual display.

FIG. 7 depicts a flow chart illustrating a process for loading the log from storage and parsing the continuous log for one or more select threads.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

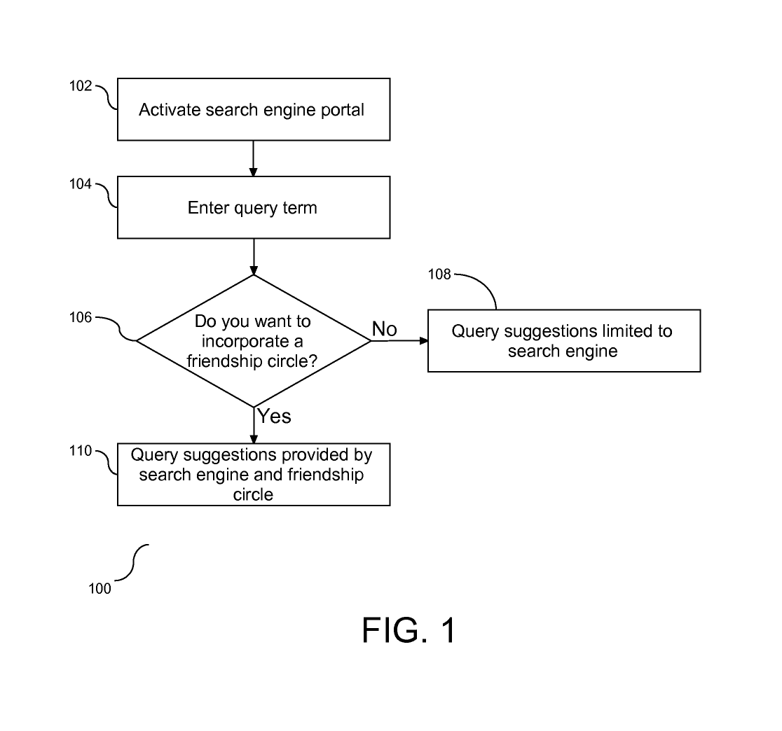

The art of query submission and associated results may be cumbersome with the growth of web sites and associated data therein. Prior art query suggestions provided by search engines are based upon browsing history patterns. FIG. 1 is a flow chart (100) illustrating a process for employing both a search engine and a social networking channel to provide a bifurcated search engine optimization. As shown, a user activates a search engine portal (102) and enters a query term (104). At the same time, the search portal enables the user to incorporate a friendship circle as a part of their query submission (106). If the user decides not to incorporate the friendship circle, query suggestions provided by the search engine will be limited to the search engine (108). Conversely, by selecting to incorporate the friendship circle, the user will receive query suggestions from both the search engine and the friendship circle (110). In one embodiment, the selection of the friendship circle is granular in nature and enables the user to select the level of friends in an associated social networking channel. Accordingly, query suggestions may be provided from the search engine, a social networking channel, or a combination of the two.

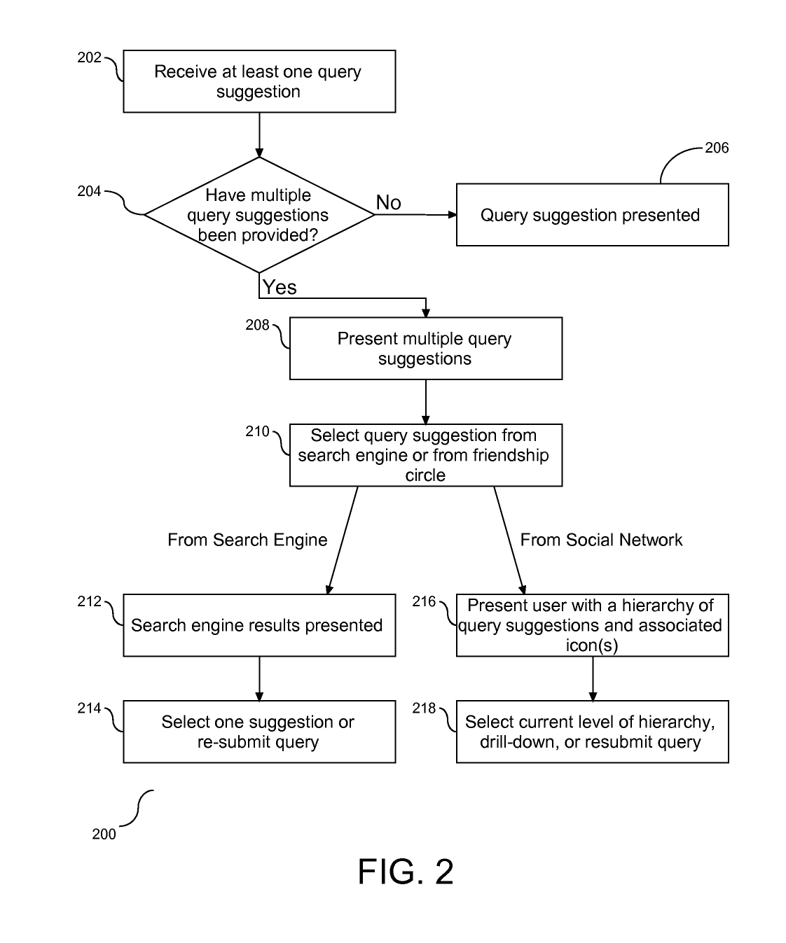

As explained above, the user may incorporate one or more friends from a social networking channel together with the search engine to solicit query suggestions. FIG. 2 is a flow chart (200) illustrating a process for utilization of the social networking channel together with a conventional search engine query. As shown, at least one query suggestion is provided from a combination of at least one friend in the social networking channel and the search engine (202). In one embodiment, the user is presented with a list of friends available in the social networking channel, and from the list may select a range of friends, including a minimum of one friend and a maximum of all friends. Similarly, in on embodiment, the friends in the social networking channel may be organized into groups, and the user may select one or more groups of friends instead of an individual friend selection. Accordingly, with respect to the social networking channel, the user may employ a selection mechanism to limit or expand a friendship circle from which query suggestions may be solicited.

Following receipt of one or more query suggestions through the social networking channel and the search engine, it is determined if multiple query suggestions have been provided (204). A negative response to the determination at step (206) limits the recommendations to a single recommendation provided by the search engine or the social networking channel. More specifically, the browser provides a visual representation of the query suggestion, and if the suggestion is from the friend(s) an associated recommendation icon is included. In one embodiment, the quantity of recommendations is presented adjacent to the recommendation icon. Similarly, in one embodiment, the recommendation icon may be in the form of a non-recommendation icon. A positive response to the determination at step (204) is followed by a presentation of multiple query suggestions (206). The user may select one of the query suggestions from the search engine or the friends or friendship circle (210). If the user elects for query results from the search engine, the search engine results are presented (212) and the user may select one of the suggestions or resubmit the query (214). Conversely, if at step (210), the user elects for query results from the social network, the user is presented with a hierarchy of query suggestions, with each level of the hierarchy having an associated recommendation and/or non-recommendation icon (216). The user may select the current level of the hierarchy, they may elect to drill-down within the hierarchy if a drill down option is available, or they may re-submit their query (218), o. Accordingly, multiple query suggestions may be presented to the user, with the suggestion provided by the social networking channel including any associated recommendations.

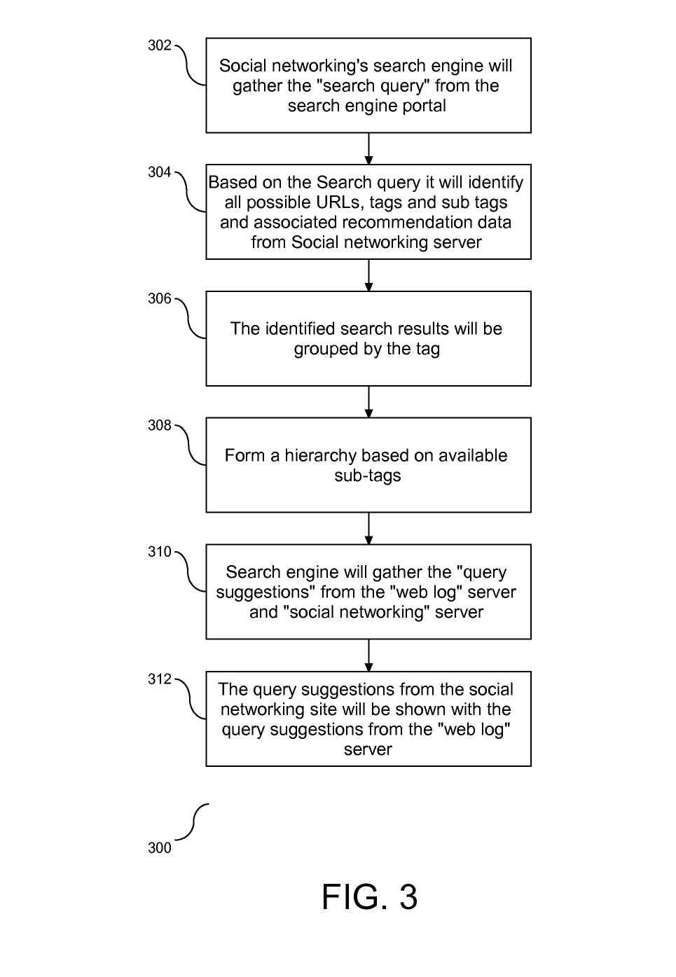

Search results provided by the social networking channel may be in the form of a hierarchical organization. FIG. 3 is a flow chart (300) demonstrating the hierarchical representation of returned query suggestions. As shown, the social networking channels are each associated with their own search engine. More specifically, the social networking channel gathers the search query presented to the search engine portal (302) and identifies all possible Universal Resource Locators (hereinafter referred to as URLs), tags, and sub-tags, together with associated recommendation data, available from the social networking channel (304). The identified search results of the social networking channel are placed in groups based upon the associated tags (306). In addition, based upon the presence of any sub-tags, the query results are formed into a hierarchical representation (308). As the query submission is bifurcated between the social networking channel and the search engine portal, the search engine gathers both the query suggestions from a web log server associated with the search engine portal and the organized query suggestions of the social networking channel (310). Following step (310), both categories of query suggestions are visually displayed (312). In one embodiment, the visual display physically separates the categories of query suggestions so that the user can effectively select one of the categories. Accordingly, the social networking channel and the search engine portal separately determine query suggestions, which are then jointly presented to the user in a manner that identifies the query suggestions from the social networking channel separate from the query suggestions from the search engine portal.

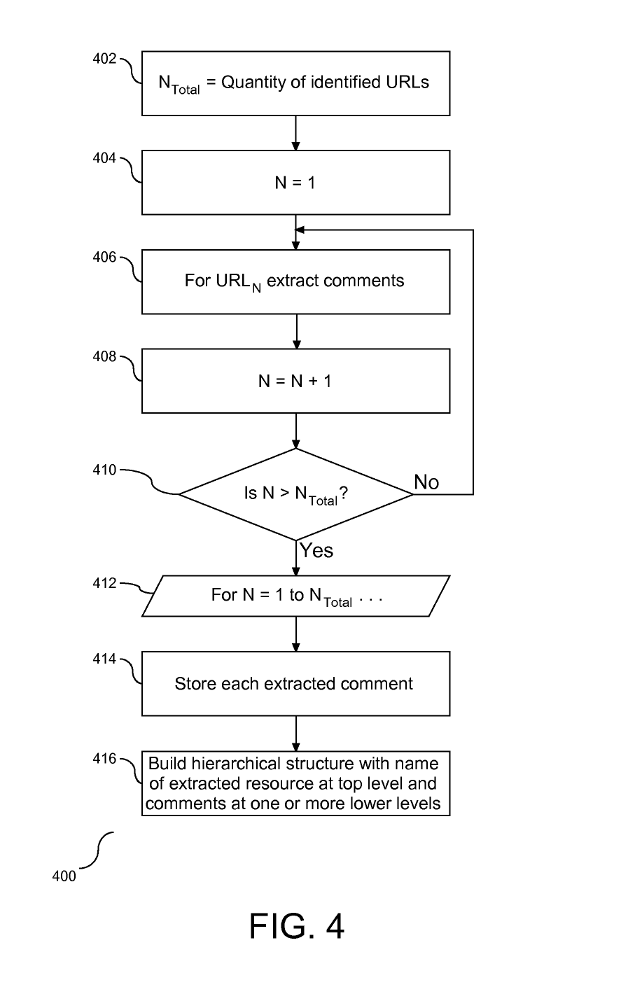

As described above, query suggestions provided by the social networking channel may be nested in a hierarchy and presented in the nested arrangement. FIG. 4 is a flow chart (400) illustrating a process for formatting the hierarchical arrangement of query suggestions. In response to submission of a query, multiple URLs are identified and assigned to the variable N_{Total} (402), and a counting variable N is initialized (404). For each URL_{N}, comments from any friends in the selected friendship circle are extracted and associated with URL_{N} (406). The variable N is incremented (408), followed by determining if comments have been extracted from all of the identified URLs (410). A negative response to the determination at step (410) is followed by a return to step (406), and a positive response to the determination at step (410) concludes the comment extraction process. Accordingly, prior to organizing the query suggestions into a hierarchical structure, comments pertaining to each identified URL are extracted for processing.

A set of results are applied to each of the extracted comments to seek common aspects among the extracted data. Based upon the range of the counting variable N from one to N_{Total} (412), rules are applied to the extracted comments to seek commonality. More specifically, the goal is to ascertain common elements among the extracted comments. Each of the extracted comments is stored (414), with the storage including identification of any inter-relationship among the extracted comments. In one embodiment, the extracted comments are stored local to a server of a service provider. Following step (414), a hierarchical structure is built with the name of an extracted resource at a top level of the structure and comments embedded within one or more lower levels of the structure (416). The hierarchy can be a two level structure or in one embodiment a multilevel structure based on concept extraction logic. Once the hierarchy is completed, the user may exploit the benefits thereof, including drilling down on select levels to receive a recommended URL and associated recommendation(s).

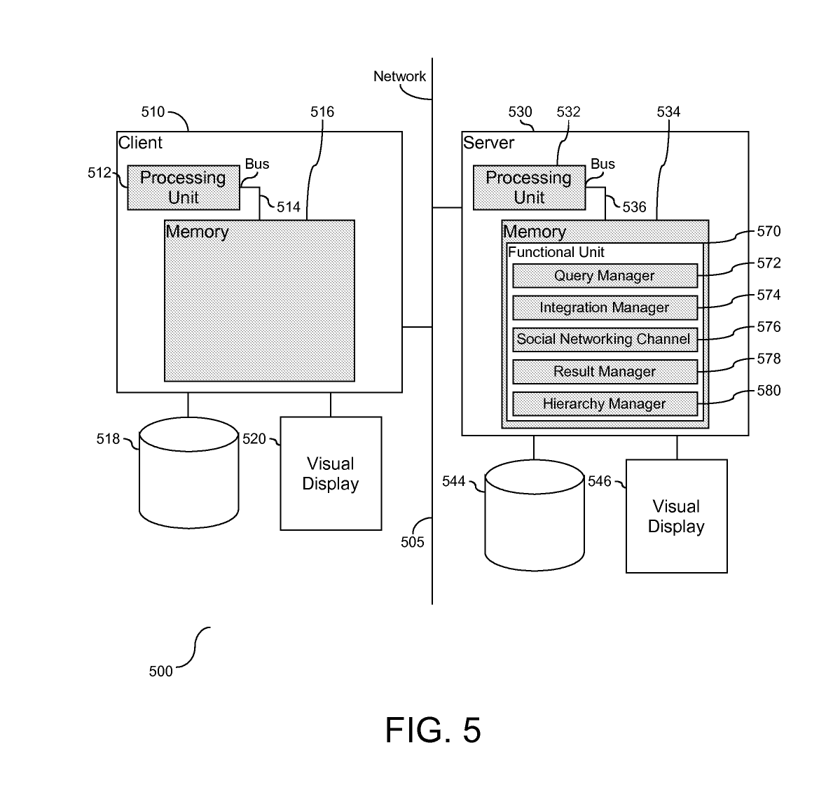

The completed hierarchy assists the user with efficiently and effectively discovering a recommended URL as a query suggestion. FIG. 5 is a block diagram (500) illustrating tools embedded in a computer system to support an efficient and effective return of query suggestions from both a search engine and a social networking channel. For illustrative purposes, a computer system is provided with a client machine (510) in communication with a server (530) across a network (505). The client machine (510) is provided with a processing unit (512) in communication with memory (516) across a bus (514). In one embodiment, client machine (510) is in communication with local data storage (518) and a visual display (520).

The client machine (510) is shown in communication with the server (530) across the network (505). In one embodiment, the server (530) is provided with a processing unit (532) in communication with memory (534) across a bus (536). As shown herein, the server (530) is in communication with at least one storage device (544) and a visual display (546). In one embodiment, the server (530) may be in communication with additional storage devices, and/or additional data centers. The storage device (544) is configured to support read and/or write operations.

A functional unit (570) is provided in communication with memory (534); the functional unit (570) supports management of query submissions. As shown, the functional unit (570) is provided with a query manager (572), an integration manager (574), a social networking channel (576), and a result manager (578). The query manager (572) functions to submit a query in the form of a query item to a search engine in communication with the server (530). The integration manager (574) is in communication with the query manager (572) and functions to integrate the submitted query with the social networking channel (576). In one embodiment, one or more friends or a friendship circle are identified within the social networking channel (576), and the integration supported by the integration manager includes selection of the identified friend or friendship circle from within the social networking channel (576). By employing the identified friend or friendship circle, the social networking channel (576) may receive the query from the search engine and support identification of one or more query suggestions. Accordingly, by incorporating the identified friend or friendship circle into the query submission, the social networking channel (576) receives the query and in return provides one or more query result suggestions.

The result manager (578) is provided in communication with the social networking channel (576). More specifically, the result manager (578) functions to return query suggestions in the form of separate first and second query suggestions. The first query suggestion emanates from the social networking channel (576) and the second query suggestion emanates from the search engine. In one embodiment, the social networking channel (576) gathers the query terms from feedback data present in the channel (576). Similarly, in one embodiment, a recommendation icon and a quantity of recommendations associated with the icon may be displayed with the first and second query suggestions. As explained herein, the friends or friendship circle impact the returned query suggestions. However, the selection of friends or the friendship circle is not fixed. In one embodiment, the integration manager (574) may be employed to amend the friendship circle. This amendment may affect the first query suggestions as returned from the social networking channel (576). Accordingly, one or more friends or friendship circles are employed as a tool to affect the returned query suggestions.

In one embodiment, the returned query suggestions are presented in a hierarchical structure. A hierarchy manager (580) is provided as a tool within the functional unit (570) and in communication with the social networking channel (576). More specifically, the hierarchy manager (580) derives a hierarchy structure for returning the first query suggestions from the social networking channel (576). The hierarchy structure is a multi-tiered structure that is derived from a name of a resource within the social networking channel (576) and comments attached to the resource. The result manager (578) incorporates the structure of the hierarchy with the returned query suggestions. This incorporation includes the result manager (578) receiving both the query suggestions and query results from different levels represented in the hierarchy. Accordingly, a multi-tiered hierarchical structure may be created by the hierarchy manager (580) to provide a multi-faceted result set in the form of query suggestions from the social networking channel (576).

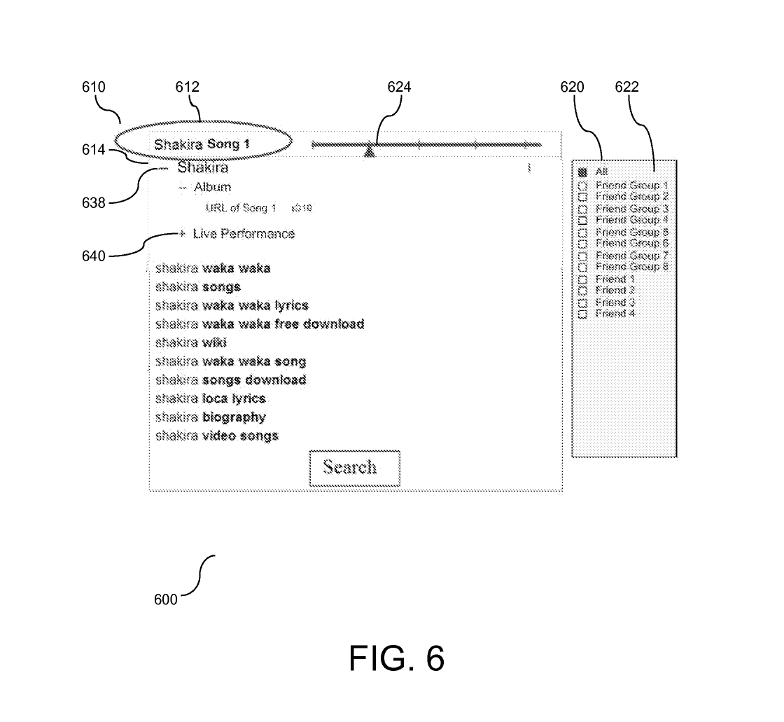

As described above, a client machine (510) is provided in communication with a visual display (520). FIG. 6 is a block diagram (600) illustrating an example of a bifurcated query suggestion presentation provided on the visual display (520). More specifically, the presentation includes a primary section (610) and a secondary section (620). The primary section (610) includes a query entry section (612), and a query result section (614). The secondary section (620) includes a social networking selection (622). As shown, an individual listing of friends is provided in the social networking section (620), with selections available from one or more specific friends, or in one limitation all of the listed friends. The selection of friends supports formation of a friendship circle. More specifically, the individual selection of two or more friends effectively forms a friendship circle. The query section (612) accepts a query submission, and a graphical element (624) is employed to change the level of contribution of query results from the selection in the social networking section (620). In the example shown herein, the second element (624) is in the form of a slider with a position of the slider affecting the contribution from the social networking channel. In one embodiment, movement of the slider increases or decreases the query suggestions as provided by the social networking channel. Accordingly, the social networking contribution may be adjusted by individual selection of friends in the social networking selection (622) and/or by adjustment of the graphical element (624) in the query section (612).

As further shown in FIG. 6, the query result section (614) presents query suggestions for submission. The query results section (614) includes query results provided by a search engine and query results provided by the social networking channel. As shown, the query results provided by the social networking channel are presented in a hierarchy. More specifically, an expanded icon (638) is provided that shows a drill down on the hierarchy. In one embodiment, the user may be provided with the icon in a non-expanded form (640). One or more icons may be provided, with each icon supporting an additional level of drill-down. In other words, in the example shown herein the hierarchy of the query results from the social networking channel includes at least three tiers of results. However, in another embodiment, the hierarchy may be limited to two tiers, or expanded to include four or more tiers. The invention should not be limited to the quantity of tiers in the hierarchy. Accordingly, multiple fields are provided in the visual display to support contribution of query suggestions from both the search engine and the social networking channel.

As identified above, the query manager (572), integration manager (574), social networking channel (576), result manager (578), and hierarchy manager (580), hereinafter referred to as tools, function as elements to support the on-line conference communication. The tools (572)-(580) are shown residing in memory (534) local to the server (530). However, the tools (572)-(580) may reside as hardware tools external to memory (534), or they may be implemented as a combination of hardware and software. Similarly, in one embodiment, the tools (572)-(580) may be combined into a single functional item that incorporates the functionality of the separate items. As shown herein, each of the tools (572)-(580) are shown local to the server (530). However, in one embodiment they may be collectively or individually distributed across a network or multiple machines and function as a unit to evaluate hardware performance. Accordingly, the tools may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

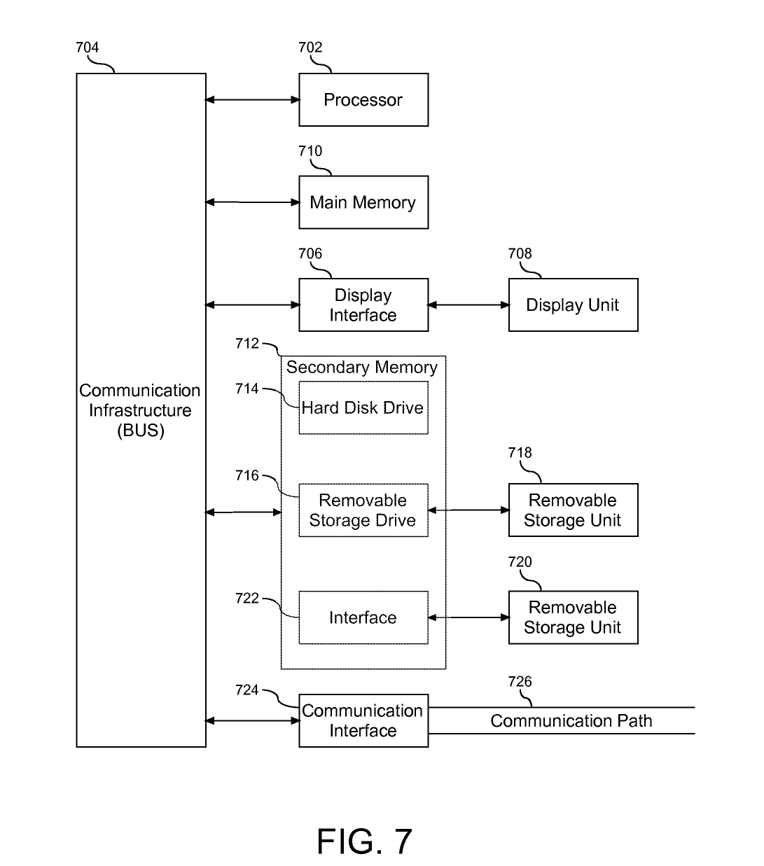

Referring now to the block diagram of FIG. 7, additional details are now described with respect to implementing an embodiment of the present invention. The computer system includes one or more processors, such as a processor (702). The processor (702) is connected to a communication infrastructure (704) (e.g., a communications bus, cross-over bar, or network).

The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712). The secondary memory (712) may include, for example, a hard disk drive (714) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by removable storage drive (716). As will be appreciated, the removable storage unit (718) includes a computer readable medium having stored therein computer software and/or data.

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) are in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method comprising:
submitting a query to a search engine, the query including a query term;
integrating the submitted query with a social networking channel, including selecting a friendship circle from the social networking channel;
the social networking channel receiving the query from the search engine and identifying at least one query suggestion and at least one suggested query result from the social networking channel; and
returning query suggestions, the query suggestions including the identified at least one first query suggestion from the social networking channel and a second query suggestion from the search engine.

2. The method of claim 1, further comprising the social networking channel gathering the query term from feedback data present in the social networking channel.

3. The method of claim 2, further comprising deriving a hierarchy structure from a name of a resource and comments attached to the resource within the social networking channel.

4. The method of claim 3, further comprising incorporating the hierarchy structure with the returned query suggestion.

5. The method of claim 4, wherein the step of incorporating the hierarchy structure includes receiving the query suggestion and query results from different levels represented in the hierarchy of the social networking channel.

6. The method of claim 1, wherein one of the first and second query suggestions includes a recommendation icon and a quantity of recommendations associated with the icon.

7. The method of claim 1, further comprising amending the friendship circle, with the amendment changing the first query suggestion from the social networking channel.

8. A computer program product comprising a computer readable storage medium having computer readable program code embodied therewith, the computer readable program code comprising:
computer readable program code configured to receive a query submitted to a search engine, the query including a query term;
computer readable program code configured to integrate the submitted query with a social networking channel, including selecting a friendship circle from the social networking channel;
the social networking channel to receive the query from the search engine and computer readable program code to identify at least one query suggestion and at least one suggested query result from the social networking channel; and
computer readable program code to return query suggestions, the query suggestions including the identified at least one first query suggestion from the social networking channel and a second query suggestion from the search engine.

9. The computer program product of claim 8, further comprising computer readable program code to support the social networking channel gathering the query term from feedback data present in the social networking channel.

10. The computer program product of claim 9, further comprising computer readable program code to derive a hierarchy structure from a name of a resource and comments attached to the resource within the social networking channel.

11. The computer program product of claim 10, further comprising computer readable program code to incorporate the hierarchy structure with the returned query suggestion.

12. The computer program product of claim 11, wherein the code to incorporate the hierarchy structure includes receiving the query suggestion and query results from different levels represented in the hierarchy of the social networking channel.

13. The computer program product of claim 8, wherein one of the first and second query suggestions includes a recommendation icon and a quantity of recommendations associated with the icon.

14. The computer program product of claim 8, further comprising computer readable program code to amend the friendship circle, with the amendment changing the first query suggestion from the social networking channel.

15. A system comprising:
a processor in communication with memory;
a functional unit in communication with memory, the function unit comprising:
a query manager to submit a query to a search engine, the query including a query term;
an integration manager in communication with the query manager, the integration manager to integrate the submitted query with a social networking channel, including selecting a friendship circle from the social networking channel;
the social networking channel to receive the query from the search engine and to identify at least one query suggestion and at least one suggested query result from the social networking channel; and
a result manager in communication with the social networking channel, the result manager to return query suggestions, the query suggestions including the identified at least one first query suggestion from the social networking channel and a second suggestion from the search engine.

16. The system of claim 15, further comprising the social networking channel to gathering the query term from feedback data present in the social networking channel.

17. The system of claim 16, further comprising a hierarchy manager in communication with the social networking channel, the hierarchy manager to derive a hierarchy structure from a name of a resource and comments attached to the resource within the social networking channel.

18. The system of claim 17, further comprising the result manager to incorporate the hierarchy structure with the returned query suggestion, including the result manager to receive the query suggestion and query results from different levels represented in the hierarchy of the social networking channel.

19. The system of claim 15, wherein one of the first and second query suggestions includes a recommendation icon and a quantity of recommendations associated with the icon.

20. The system of claim 15, further comprising the integration manager to amend the friendship circle, with the amendment changing the first query suggestion from the social networking channel.
